(19) United States
(12) Patent Application Publication
(10) Pub. No.: US 2017/0140647 A1
(43) Pub. Date: May 18, 2017

(54) TRAFFIC LAW INDICATOR FOR VEHICLE

(71) Applicant: Continental Automotive Systems, Inc., Auburn Hills, MI (US)

(72) Inventor: Clinton Schumann, Holly, MI (US)

(21) Appl. No.: 14/943,239

(22) Filed: Nov. 17, 2015

(51) Int. Cl. G08G 1/0967

(52) U.S. Cl. CPC G08G 1/0967

(57) ABSTRACT

An indicator used to alert a driver that turning right is impermissible when a traffic light is illuminated red, where the indicator is part of a component in the vehicle, such as the instrument cluster, radio, lamp, or the like. The information regarding the local traffic law directed to turning right when the traffic signal is illuminated red is obtained through a detection device, such as the vehicle's GPS system, a camera, or the like. The driver is informed that turning right at an upcoming intersection is allowed or impermissible, improving the flow of traffic due to drivers having knowledge when turning right is permissible, and not waiting at the intersection when unsure of the local traffic ordinance. If turning on red is impermissible, the driver is informed of this traffic ordinance, and refrains from making a right turn, thus avoiding committing a traffic violation.

### FIELD OF THE INVENTION

The invention relates generally to a device which provides increased awareness of local traffic laws to the driver of a vehicle, such as when a traffic signal is illuminated red (signaling oncoming traffic to stop), and turning on red is not allowable.

### BACKGROUND OF THE INVENTION

Certain traffic intersections which have a traffic signal may have different regulations or laws, depending upon the location of the traffic intersection. At some traffic intersections, making a right turn when the signal is illuminated red (to provide a signal to oncoming traffic to stop), i.e., “right turn on red,” is allowed when there are no other vehicles passing through the intersection. Typically, there is a sign to inform the driver of the vehicle that turning right is permitted when the traffic signal is illuminated red.

However, there are traffic intersections where it may be difficult to see the sign indicating that turning (while the red lamp of the traffic signal is illuminated) is permissible, or the driver may not see the sign because the driver's attention is focused on the other vehicles nearby. If the driver does not see the sign, or the sign is not readily visible, the driver may assume turning on red is permissible, and turn when the signal is illuminated red, violating the local traffic ordinance, and potentially receiving a traffic citation.

Accordingly, there exists a need for a device which provides an indication that making a right turn while a traffic light is illuminated red, is permissible at an intersection.

### SUMMARY OF THE INVENTION

The present invention is an indicator used to alert a driver of local traffic laws, such as that it is permissible to turn right when a traffic light is illuminated red, where the indicator is part of a component in the vehicle, such as the instrumentation panel, radio, lamp, or the like. In one embodiment, the information regarding the local ordinance directed to turning right when the traffic signal is illuminated red is obtained through a detection device, such as the vehicle's GPS system, a camera, or the like.

This solution provides the driver with an indication that turning right at an upcoming intersection is allowed, improving the flow of traffic due to drivers having an indication that making a right turn is permissible, and not waiting at the intersection when unsure of the local traffic law. The present invention also may reduce traffic infractions since the driver of the vehicle is aware that turning when the traffic light is illuminated red is not permissible, preventing the driver from turning right when not permitted.

In one embodiment, the present invention is traffic law indication system, which includes a vehicle, a no-turn indicator which is part of the vehicle, a detection device able to detect at least one local traffic law, and is operable with the no-turn indicator, and a traffic signal having multiple lamps. The no-turn indicator is activated to alert a driver of the vehicle of at least one local traffic law, such as when turning right on red is permissible, when the vehicle is a predetermined distance away from the traffic signal.

The detection device may be a GPS system, which is able to detect the local traffic law directed to making a right turn at an intersection, or a camera which is able to detect a “No Turn On Red” sign.

In one embodiment, the no turn indicator is activated when the vehicle is located at a predetermined distance from the traffic signal, regardless of which of the lamps of the traffic signal is illuminated.

In another embodiment, the vehicle includes an instrument cluster, and the no-turn indicator is part of the instrument cluster.

In yet another embodiment, the indicator includes a graphic, and the graphic is illuminated when the indicator is activated. The graphic may be illuminated when one of the lamps of the traffic signal is illuminated, and the vehicle is located at a predetermined distance from the traffic signal, or when the vehicle is stopped at the intersection.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a vehicle located at an intersection, with the vehicle having a traffic law indicator, according to embodiments of the present invention;

FIG. 2 is a diagram of part of the interior of a vehicle having a traffic law indicator, according to embodiments of the present invention;

FIG. 3 is a diagram of a global positioning system having a traffic law indicator, according to embodiments of the present invention; and

FIG. 4 is an interior view of a vehicle having an alternate embodiment of a traffic law indicator, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

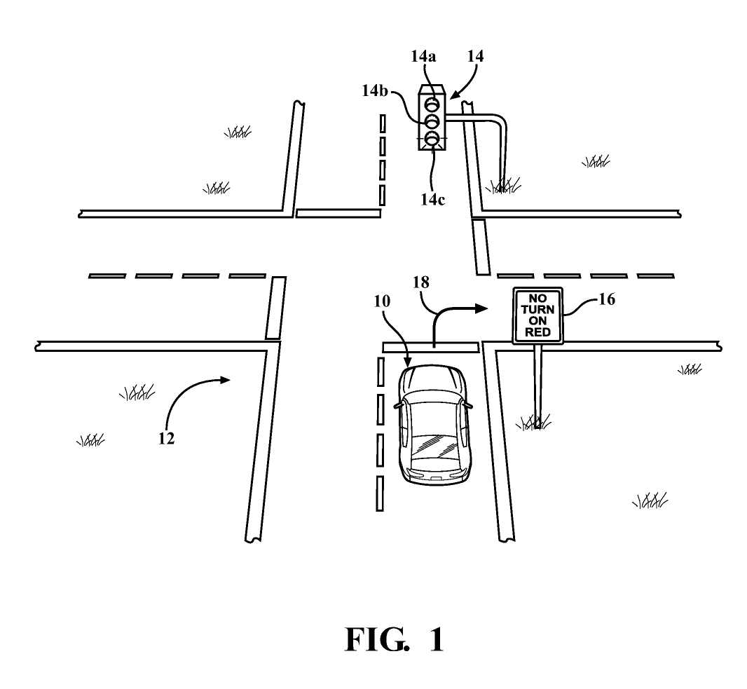

A vehicle having a traffic law indicator system according to the present invention is shown in FIG. 1 generally at 10. The vehicle 10 is located at an intersection, shown generally at 12, where the intersection 12 includes a traffic signal, shown generally at 14, and a sign 16. The traffic signal 14 includes three different lamps, a top lamp 14a, which is red, a middle lamp 14b, which is yellow, and a bottom lamp 14c, which is green. The top lamp 14a is activated in a first mode of operation, and alerts oncoming vehicles to stop at the intersection 12, the middle lamp 14b is activated in a second mode of operation, and provides an indication that the traffic signal 14 is transitioning from the bottom lamp 14c to the top lamp 14a, and the bottom lamp 14c is activated during a third mode of operation, and alerts oncoming vehicles to proceed through the intersection 12.

The sign 16 has text or some other indication that making a right-hand turn at the intersection 12 is not permitted when the top lamp 14a is illuminated. In one embodiment, the sign 16 may state “No Turn On Red,” and in other embodiments there may be a symbol, or other visual indicating that making a right-hand turn at the intersection 12 is not permitted when the top lamp 14a is illuminated.

The intersection 12 is located in a municipality where vehicles travelling through the intersection 12 are not allowed to make a right-hand turn, as indicated by arrow 18, when the top lamp 14a is illuminated. The purpose of the sign 16 is to provide an indication to the driver of the vehicle 10 that conducting the right-hand turn 18 at the intersection 12 is not permitted. However, there are situations where the driver may not be aware of this traffic law, either due to the driver of the vehicle 10 not noticing the sign 16 because the driver is focused on surrounding traffic, the sign 16 being damaged because of inclement weather, or being struck by another vehicle, or the sign has been removed for repairs by the local municipality. If the driver of the vehicle 10 is not aware that conducting the right-hand turn 18 at the intersection 12 is not permitted, and the driver proceeds with making the right-hand turn 18, the driver of the vehicle 10 is in violation of the local traffic law, and is at an increased risk for receiving a traffic citation.

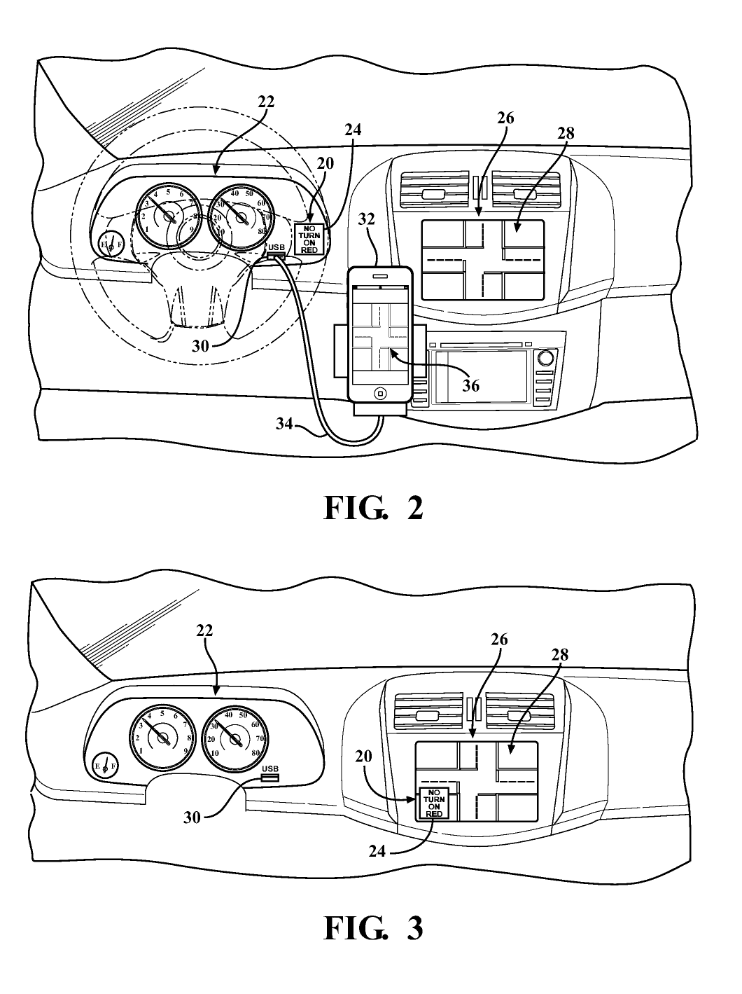

The vehicle 10 also includes a traffic law indicator, which is in this embodiment is a no-turn on red indicator, shown in a first embodiment in FIG. 2 generally at 20. The indicator 20 is part of an instrument cluster, shown generally at 22. The cluster 22 may include several different gauges, such as a speedometer, tachometer, fuel gauge, temp gauge, and the like. The indicator 20 in this embodiment is a graphic 24 that is selectively illuminated when the vehicle 10 is located at an intersection, such as the intersection 12 shown in FIG. 1, where conducting the right-hand turn 18 is not permitted.

In one embodiment, the graphic 24 is illuminated when the vehicle 10 is located at a predetermined distance from the traffic signal 14, regardless of which of the lamps 14a,14b,14c is illuminated. In another embodiment, the graphic 24 may be illuminated when the top lamp 14a is illuminated, and the vehicle 10 is located at a predetermined distance from the traffic signal 14. In yet another embodiment, the graphic 24 may be illuminated when the vehicle 10 is stopped at the intersection 12.

As mentioned above, the indicator 20 is part of the instrument cluster 22. In order for the indicator 20 to provide proper notification to the driver of the vehicle 10 that conducting the right-hand turn 18 is not permitted, the activation of the indicator 20 must correspond to the proper traffic law. In one embodiment, the vehicle 10 is equipped with a detection device, which is used to determine whether conducting the right-hand turn 18 at the intersection 12 is permissible. In this embodiment, the detection device is a GPS system, shown generally at 26, and the indicator 20 is in communication with the GPS system 26. The GPS system 26 is able to retrieve local speed limits, maps, construction notifications, as well as other local traffic laws, such as when making a right-hand turn is permissible when a traffic signal is indicating a vehicle must stop at an upcoming intersection.

In operation, the GPS system 26 detects local traffic laws, such as speed limits, and whether or not turning right at the intersection 12 is permissible when the first lamp 14a of the traffic signal 14 is illuminated. The GPS system 26 detects the local traffic laws, and as the vehicle 10 approaches the intersection 12, if conducting the right-hand turn 18 is impermissible, the GPS system 26 sends a signal to the indicator 20 such that the graphic 24 is illuminated. The driver of the vehicle 10 then becomes aware that conducting the right-hand turn 18 at the intersection 12 is impermissible.

In an alternate embodiment, the indicator 20 may be part of the GPS system 26, as opposed to being part of the instrument cluster 22. This is shown in FIG. 3, where the indicator 20 is part of the navigation screen 28, and may be activated in any of the ways mentioned above to provide an indication to the driver of the vehicle 10 that conducting the right-hand turn 18 is impermissible at the intersection 12 when the top lamp 14a is illuminated.

In an alternate embodiment, the instrument cluster 22 may also include a USB connector 30, which is connected to a cell phone 32 using a cable 34, shown in FIG. 2. The instrument cluster 22 may access the cell phone 32 having a GPS system, shown generally at 36. The GPS system 36 of the cell phone 32 may be used to detect local traffic laws, and communicate to the instrument cluster 22 that conducting the right-hand turn 18 is impermissible. In yet another alternate embodiment, the instrument cluster 22 may communicate with the cell phone 32 wirelessly, such as through a wi-fi connection. In yet another embodiment, the indicator 20 is located on the screen of the cell phone 32.

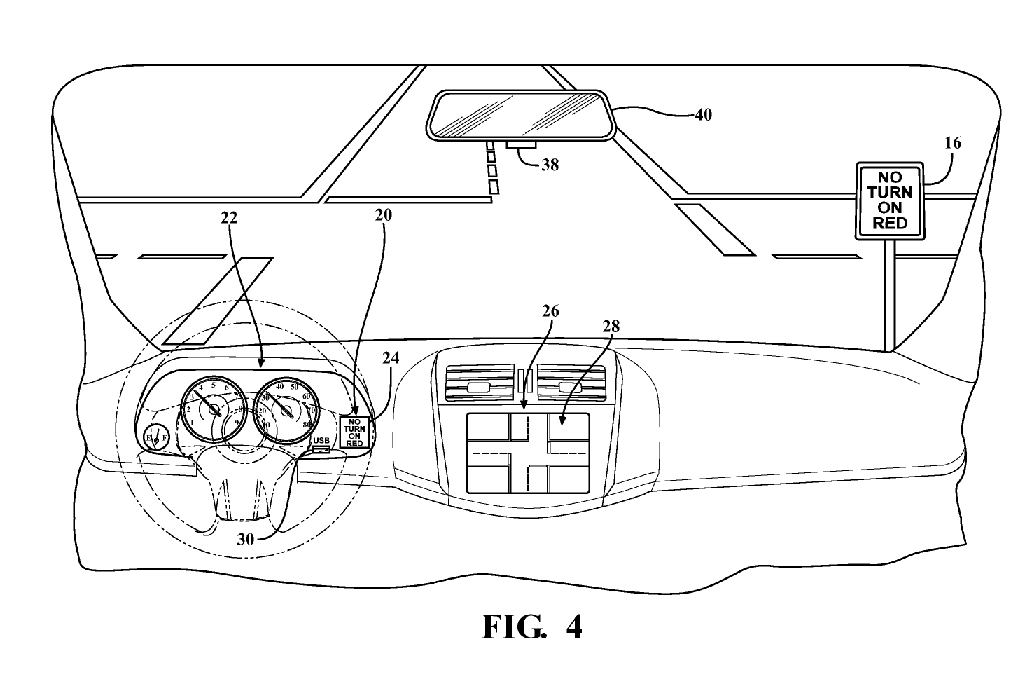

Another alternate embodiment of the invention is shown in FIG. 4, with like numbers referring to like elements. In this embodiment, the detection device is a camera 38 mounted inside the vehicle 10 below the rear view mirror 40. Although the camera 38 is mounted as shown in FIG. 4, it is within the scope of the invention that the camera 38 may be mounted anywhere in the interior or on the exterior of the vehicle 10 and perform the same function. The camera 38 is interfaced with the indicator 20, and the camera 38 functions to detect the sign 16, once the sign 16 is detected by the camera 38, the indicator 20 is activated to alert the driver of the vehicle 10 that conducting the right-hand turn 18 at the intersection is impermissible.

In additional embodiments, the indicator may be used to alert the driver of the vehicle 10 of other traffic laws or ordinances, such as, but not limited to, when the vehicle 10 has entered a “no passing zone,” deer crossing, a school zone where different speed limits are enforced during specific times of the day, or if the no right-hand turn law is enforced at specific times of the day.

In yet another embodiment, the indicator 20 may also be modified to notify the driver of the vehicle 10 of various traffic laws when traveling in other countries, which the driver may not be aware of. The GPS system 26 of the vehicle 10, or the GPS system 36 of the cell phone 32, may be used to download traffic laws of the local municipality, and the indicator 20 is then activated and configured to alert the driver of the vehicle 10 of the local traffic laws.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A traffic law indication system, comprising:
a vehicle;
an indicator, the indicator being part of the vehicle; and
a detection device, the detection device being part of the vehicle and operable with the indicator;
wherein the detection device detects at least one local traffic law, and the indicator is activated to alert a driver of the vehicle of the at least one local traffic law.

2. The traffic law indication system of claim 1, further comprising an instrument cluster, wherein the indicator is part of the instrument cluster.

3. The traffic law indication system of claim 1, the indicator further comprising a no-turn indicator.

4. The traffic law indication system of claim 1, further comprising a traffic signal, where in the indicator is activated when the vehicle is a predetermined distance from the traffic signal.

5. The traffic law indication system of claim 4, the traffic signal further comprising at least one lamp which is selectively illuminated, wherein the indicator is activated when turning is impermissible while the at least one lamp is illuminated.

6. The traffic law indication system of claim 4, wherein the indicator is activated when the vehicle is located at a predetermined distance from the traffic signal.

7. The traffic law indication system of claim 4, the indicator further comprising a graphic, wherein the graphic is illuminated when the indicator is activated.

8. The traffic law indication system of claim 7, wherein the graphic is illuminated when the at least one lamp is illuminated, and the vehicle is located at a predetermined distance from the traffic signal.

9. The traffic law indication system of claim 7, wherein the graphic is illuminated when the vehicle is stopped at the intersection.

10. The traffic law indication system of claim 1, the detection device further comprising a GPS system.

11. The traffic law indication system of claim 1, further comprising a sign providing notification of the at least one traffic law, and the detection device further comprising a camera which detects the sign.

12. A traffic law indication system, comprising:
a vehicle;
a no-turn indicator, the no-turn indicator being part of the vehicle;
a detection device able to detect at least one local traffic law, the detection operable with the no-turn indicator; and
a traffic signal;
wherein the no-turn indicator is activated to alert a driver of the vehicle of the at least one local traffic law when the vehicle is a predetermined distance from the traffic signal.

13. The traffic law indication system of claim 12, further comprising an instrument cluster, wherein the no-turn indicator is part of the instrument cluster.

14. The traffic law indication system of claim 12, the traffic signal further comprising:
a first lamp operable for illuminating when the traffic signal is in a first mode of operation;
a second lamp operable for illuminating when the traffic signal is in a second mode of operation; and
a third lamp operable for illuminating when the traffic signal is in a third mode of operation;
wherein the no-turn indicator is activated when it is impermissible to turn while the first lamp is activated.

15. The traffic law indication system of claim 14, the indicator further comprising a graphic, wherein the graphic is illuminated when the no-turn indicator is activated.

16. The traffic law indication system of claim 15, wherein the graphic is illuminated when the top lamp is illuminated, and the vehicle is located at a predetermined distance from the traffic signal.

17. The traffic law indication system of claim 15, wherein the graphic is illuminated when the vehicle is stopped at the intersection.

18. The traffic law indication system of claim 12, the detection device further comprising a GPS system.

19. The traffic law indication system of claim 12, further comprising a sign providing notification of the at least one traffic law, and the detection device further comprising a camera which detects the sign.
